(19) United States
(12) Patent Application Publication
(10) Pub. No.: US 2018/0087752 A1
(43) Pub. Date: Mar. 29, 2018

(54) ILLUMINATION DEVICE

(71) Applicant: Lumenico Ltd, Bedfordshire (GB)

(72) Inventor: Michael Andrew Atkinson, Bedfordshire (GB)

(21) Appl. No.: 15/715,469

(22) Filed: Sep. 26, 2017

Related U.S. Application Data
(60) Provisional application No. 62/399,810, filed on Sep. 26, 2016.

(51) Int. Cl. F21V 15/01; H05B 33/08; H05B 37/02

(52) U.S. Cl. CPC F21V 15/01; H05B 37/0209; H05B 33/0857; H05B 33/0845

(57) ABSTRACT

An illumination device is provided. The illumination device includes a base; an upright portion extending from the base; a light source located in the base and projecting into the upright portion; and an electronic controller that controls the light source according to a program, the program including a plurality of different preprogrammed control functions.

### CROSS REFERENCE TO RELATED APPLICATION

The present application claims priority to U.S. Provisional Patent Application No. 62/399,810, filed Sep. 26, 2016, which is incorporated by reference herein in its entirety.

### FIELD

The present invention relates to an illumination device. Particular embodiments of the invention relate to a decorative device that provides illumination in a home or other setting, such as, for example, a night light.

### BACKGROUND

Many people, especially small children, prefer to have a low level light illuminated during the might while they sleep. These are sometimes referred to as a “night light”. Night, lights can provide a low level light to, prevent absolute darkness and/or to provide light for walking to a bathroom, for example. Such lights can provide comfort as well as in increased level of safety by providing a low level light.

Accordingly, a decorative device that also provides illumination in, for example, a bedroom at night, would be desirable.

There is need for a night light or other illumination device that provides enhanced features at an affordable puce point. There is a further need for packaging that enables convenient display of the device.

### SUMMARY

Embodiments of the invention satisfy these needs by providing (1) a night light that has a clear upright portion with a decorative design that presents a desirable visual effect when a light source is projected up into the unright portion; and (2) packaging that allows an external power source to be connected to the device while the device is in the packaging.

In one aspect of the invention, an illumination device includes a base; an upright portion extending from the base; a light source located in the base and projecting into the upright portion; and an electronic controller that controls the light source according to, a program, the program including a plurality of different preprogrammed control functions.

Some embodiments include an input device connected to the controller and configured to convey a command of a user to the controller.

In some embodiments, the input device is a plurality of contact switches configured to be touched by the user.

In some embodiments, the control functions include changing a color of the light source.

In some embodiments, the control functions include changing an intensity of the light source.

In some embodiments, the control functions include a timed change in a parameter of the light source.

In some embodiments, the control functions include (1) changing a color of the light source, (2) changing an intensity of the light source, and (3) a timed change in a parameter of the light source.

Some embodiments include a switch having three positions that include (1) an ON position at which power is supplied to the controller, (2) an OFF position at which no power is supplied to the controller, and (3) a trial position at which power is supplied to the controller and a trial program is run that exhibits a predefined set of features of the device.

Some embodiments include an exhibition mode programmed in the controller that controls the light source in a predetermined manner.

In some embodiment, the predetermined manner can be modified by a user.

In sonic embodiments, the light source reverts back to the predetermined manner when a set duration has expired with no activity of a remote control.

In some embodiments, the light source comprises a plurality of individual light sources.

In some embodiments, the upright portion can be removed from the base without damaging the upright portion and without damaging the base, and the upright portion can be reattached to the base without damaging the upright portion and without damaging the base.

In some embodiments, the upright portion comprises a clear area and a printed area.

In some embodiments, the printed area is configured to accept a colored liquid applied to the printed area by a user. Other freeform areas can also be provided.

In another aspect of the invention, a packaged product combination includes an illumination device, the illumination device having a base, an upright portion extending from the base, a light source located in the base and projecting into the upright portion, an electronic controller that controls the light source according to a program, the program including a plurality of different preprogrammed control functions, and a power supply port in the base that is configured to receive power from an outside source and supply the power to the controller; a remote controller that can remotely control functions of the illumination device; and packaging that includes a container body, a clear product window in one side of the container body and through which the illumination device can be viewed by a potential buyer of the combination, an openable and closeable access opening in a first side of the container body, the access opening providing access to the power supply port in the base when the device is in the container body such that the outside power source is electrically connected to the controller.

Some embodiments include a user operable switch that activated a demonstration mode of the illumination device, the user operable switch being operable while the illumination device is completely inside the packaging.

Some embodiments include an exhibition mode programmed in the controller that, controls the light source in a predetermined manner, wherein the predetermined manner can be modified by a user, and the light source reverts back to the predetermined manner when a set duration has expired with no activity of the remote control.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is perspective view of an illumination device in accordance with exemplary embodiments of the invention;

FIG. 2 is a perspective view of a base unit in accordance with exemplary embodiments of the invention;

FIG. 3 is a front perspective view of a packaged product m accordance with exemplary embodiments of the invention;

FIG. 4 is a side view of the packaging shown in FIG. 3;

FIG. 5 is a rear perspective view of the packaging shown in FIG. 3;

FIG. 6 is a lower rear perspective view of the packaging shown in FIG. 3;

FIG. 7 is a front sectional view of an illumination device in accordance with exemplary embodiments of the invention;

FIG. 8 is a side sectional view of the illumination device shown in FIG. 7;

FIG. 9 is a top sectional view of the illumination device shown in FIG. 7;

FIG. 10 is a perspective view of a printed circuit board in accordance with exemplary embodiments of the invention;

FIG. 11 is a schematic view of an illumination device in accordance with exemplary embodiments of the invention in a disassembled state;

FIG. 12 is a partial schematic view of an illumination device in accordance with exemplary embodiments of the invention in a disassembled state;

FIG. 13 is a schematic view of an illumination device in accordance with exemplary embodiments of the invention in an assembled state;

FIG. 14 is a partial schematic view of an illumination device in accordance with exemplary embodiments of the invention in an assembled state;

FIG. 15 is an upper front view of an illumination device in accordance with exemplary embodiments of the invention;

FIG. 16 shows markers in accordance with exemplary embodiments of the invention;

FIG. 17 is a perspective view of a base writ in accordance with exemplary embodiments of the invention, and

FIG. 18 is a schematic view of a remote controller in accordance with exemplary embodiments of the invention.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION

The following description of the preferred embodiment(s) is merely exemplary in nature and is in no way intended to limit the invention, its application, or uses.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “connected,” “coupled,” “interconnected,” and similar refer to a relationship wherein structures are secured or attached to one another either directly or indirectly through intervening structures, as well as both movable or rigid attachments or relationships, unless expressly described otherwise. The term “fixed” refers to two structures that cannot be separated without damaging one of the structures. The term “filled” refers to a state that includes completely filled or partially filled.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Features of the present invention may be implemented in software, hardware, firmware, or combinations thereof The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc) and my include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Exemplary illumination devices are shown in the drawings. The devices comprise an upright portion designed to fit into a base. In particular embodiments, the upright portion is screen-printed to display a pleasant image (e.g., a cartoon horse) and is made from a clear acrylic. The upright can also be completely clear of printing (freeform), and can be used with pens like a doodle or notice hoard. In other embodiments, other images and materials can be used. In some embodiments, portions of the image are screen-printed (or otherwise prepared) such that an ink or other material can be applied to those portions to enable a user to customize the device. Other preparations can include laser etching, grinding, stippling, or other mechanical surface treatments. The base can include one or more light sources (such as, for example, LEDs) that project into the upright portion causing a pleasant spread of the light from the light source(s). The light sources can be powered by a battery, a USB connection, or another power source. Further, a remote control or other user interface can be used to control characteristics or the light sources, such as, for example, color and brightness.

In one embodiment, the device includes an ABS injection molded base; a dear acrylic upright portion, screen printed, fitted to the base; a printed circuit board assembled inside the base; and a remote control. Examples of power sources are non-rechargeable batteries (three AA batteries, for example), rechargeable batteries, or a power cable that connects to mains power with or without a transformer (USB or micro USB, for example).

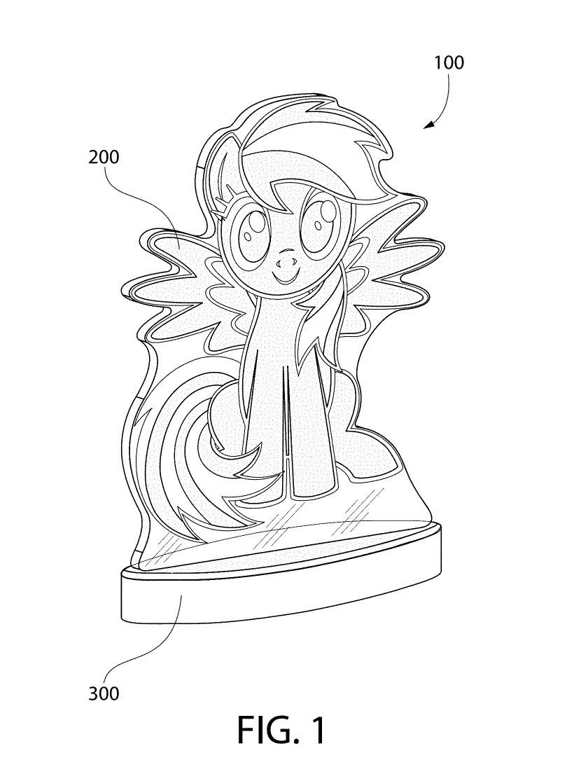

FIG. 1 shows a device 100 according to an exemplary embodiment. The device includes an upright portion 200 that is, in this example, in the shape of a pony. Upright portion 200 is inserted into a base 300 that houses a power source, one or more lights sources, and various switches and/or control buttons. A remote control can control the colors of the light sources (for example, LEDs). The remote control can have several colored buttons enabling the user to change the color emitted by the device. Further, the remote control can include other buttons. The remote control can have any number of buttons for a plurality of future functions. A sleep button can gently fade the light to a low-level light. A timer button can gently fade the light to a low-level light and then turn off the light after a predetermined time period (for example, one hour). A “side lamp” button can cause the light sources to provide maximum bright white light for activities such as night time reading and bottle or breast feeding. A “rainbow” button can cause the light sources to cycle rainbow colors. Light sources such as LEDs can cause low heat and have long lives.

The pony design shown in FIG. 1 is just one example of shapes or designs that can be provided. Other animals, cartoon characters, sports team logos, sports equipment, vehicles, sayings, or any other shape or design can be provided. A blank upright portion can be used to provide a freeform writable surface like a white board.

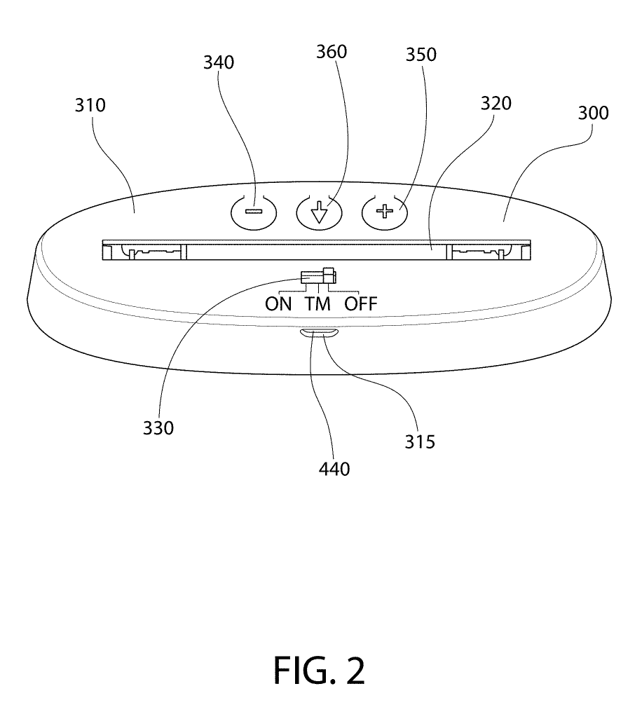

FIG. 2 shows base 300 according to one embodiment. Base 300 can have a form factor convenient for packagine. For example, base 300 can have a sufficiently small depth such that the packaging box is not thick, and therefore retailers can store numerous packages on shelves at once. Base 300 has a slot 320 that receives upright portion 200. This example shows one rectangular slot 320. Other embodiments have different shape slots and/or multiple slots.

In the exemplified embodiment, base 300 has a body 310 and includes a slide switch 330 providing three options: ON, OFF, and “Try-Me” or “TM,” Try-Me (discussed more detail below) enables a potential buyer to press a button (while the device is still in the package) that causes the device to illuminate for the potential buyer. Although a slide switch is shown in this example, other types of switches such as, for example, a touch sensitive switch or an optically activated switch can be used.

Further, it is shown that base 300 can include different buttons for conveniently carrying out different functions. These buttons can also be useful in the event the remote control is misplaced or with a model sold without the remote control. The remote control can be optional purchased. Generally, a plus button 350 can increase brightness, a minus button 340 can decrease brightness, and an enter button 360 (identified with a downward arrow) can function as an ON/OFF button if held down for a predetermined period of time (the example two or more seconds). As will be discussed in further detail below, when in “rainbow mode” (which is a mode that circles through multiple colors), a short press of enter button 360 pauses color changing, and a subsequent short press resumes color changing. Further, within a predetermined time (for example five seconds) of pausing, pressing plus button 350 or minus button 340 can adjust the color forward or backward, respectively. Although buttons that are activated by pressing are shown, other user input devices can be used. For exampe, touch sensitive areas or optically triggered areas can be used to perform the functions of enter button 360, plus button 350, and minus button 340.

A more detailed explanation of the potential functionality of the buttons follows. The functionalities of the three buttons 340, 350, 360 are dependent on the position of slide switch 330. In this example, the OFF position is a hard power OFF condition, where the power supply (battery and/or USB power) is entirely disconnected from the processor controller (discussed more below). In the ON position, the power supply is connected to the processor/controller. When the processor is in normal power mode (slide switch in the ON position), a remote control sensor (for example, IR or RF) is in read mode (thus enabling the device to receive signals from the remote control), and the three buttons are in ‘Normal’ mode.

Enter button 360 has, in this example, a dual-purpose circuit. The dual-purpose circuit can: a) provide input to the processor, and b) initiate a self-sustaining power circuit to wake the processor from a zero-standby power condition, allowing for practically indefinite lifespan of any batteries that are included with the device for demonstration (“Try-Me”) purposes. After a Try-Me event, the processor can turn itself off back to a zero-standby power state, and can be subsequently reinitiated by dual-purpose enter button 360. The processor in this example remembers the last setting of the Try-Me function.

The following is one example of how a color can he set for the light source. The durations in this example are for illustration purposes and can he different in other examples. A short press of enter button 360 (e.g., example, between 100 ms and 2000 ms) cycles between Rainbow Mode and a fixed color in the Rainbow cycle. If fixed color mode is chosen, then the color shown is the color showing at the time enter button 360 was pressed. At this time, for a period of five seconds, plus button 350 and minus button 340 can be used to ‘fine tune’ the color after enter button 360 has been pressed to choose fixed color mode. Each press of plus button 350 moves the color forward in the rainbow cycle (in 100 ms change steps). Each press of minus button 340 moves the color backwards by the same amount. This ‘Color Fine Tune’ functionality is only active for up to five seconds after enter key 360 has been used to select fixed color mode, and lapses after five seconds of no further plus button 350 or minus button 340 use.

Other than when the ‘Color Fine Tune’ functionality is active, plus button 350 and minus button 340 are used as ‘Dimmer Control’ for the light source brightness. In this example, there are 20% steps for momentary presses and a reasonable ramp up and down for continuous presses (for example, over a four second period). Other durations can be used.

In this example, when slide switch 330 is moved to the Try-Me position, the processor enters an ultra-low power mode. In this mode, no input (for example, IR or RF) from the remote control is read, but enter button 360, plus button 350 and minus button 340 are operational. In the Try-Me mode, when any of one of enter button 360, plus button 350, or minus button 340 is pressed (for a short or long duration) the light source will display a predetermined ‘Try-Me Color Sequence’. An example of a Try-Me Color Sequence is cycling through White, Blue, Hot Pink, Orange, Light Blue for a duration of 1.5 seconds for each color with a quick but smooth cross-fade. In this example, all colors at 100% brightness. In other examples, the colors can be at a brightness of less than 100%.

When the Try-Me Color Sequence is complete, the last color will quickly fade to zero and the unit will stay in a “zero-standby power state”. Try-Me mode is meant to be a quick and colorful demonstration of the device. The device adjusts colors, timing, and sequence to achieve this aim.

A default ON condition is the default condition when there is no remembered color or setting. One possible default is Rainbow Mode at 100% brightness.

This example includes a First Power ON condition which is the condition when the PCB is first powered up. This can include a self-test sequence of red, green, blue, and white for 1 second each at 100% so testers can check the light source easily when the PCB is first powered up.

This example also includes an “Exhibition Mode”. It can be challenging to control numerous adjacent devices in an exhibition or other environments by the remote control. For example, pressing the power button on the remote control may cause one device to power ON and another device to power OFF. Further, potential customers can use the remote control in a manner that disrupts the color display, that the seller wishes to exhibit. But the device can be programmed such that, by pressing and/or holding down one or more buttons, the devices can enter an. Exhibition Mode that is consistent across all devices in the exhibit. In such a mode, all the devices can be in a consistent state for displaying the devices to potential buyers. For example, Exhibition Mode cart allow a user to set a Demo Color which the light will return to after 30 seconds on inactivity of the remote control. This returns device 100 to the preprogrammed exhibition light sequence after a potential buyer finishes operating device 100 so that subsequent potential buyers can witness the exhibition light sequence.

Exhibition Mode can, for example, be implemented in the following way: (1) Exhibition Mode is activated when slide switch 330 is switched to the ON position, and plus button 350 and minus button 340 are held down at the same time for more than two seconds; (2) the light source flashes white and thereafter the operator has five seconds to choose the Demo Color using the remote control; (3) after that the light source flashes white again and the chosen Demo Color is set. With Exhibition Mode set, the processor will reset the light source to Demo Color every 30 seconds. Exhibition Mode is remembered on power OFF. Other features may be set, like brightness, or enabled or disabled in Exhibition Mode.

To exit Exhibition Mode, the operator holds down plus button 350 and minus button 340 at the same time for more than two seconds but does not enter a color using the remote control. Thereafter the processor enters hack in to its ‘Normal’ mode and defaults to Rainbow Mode.

Also shown in FIG. 2 is an external power port 440 that is accessible through an opening 315 in base body 310. External power port 440 can be used to power the device with external power and/or it can he used to charge rechargeable batteries inside base 300.

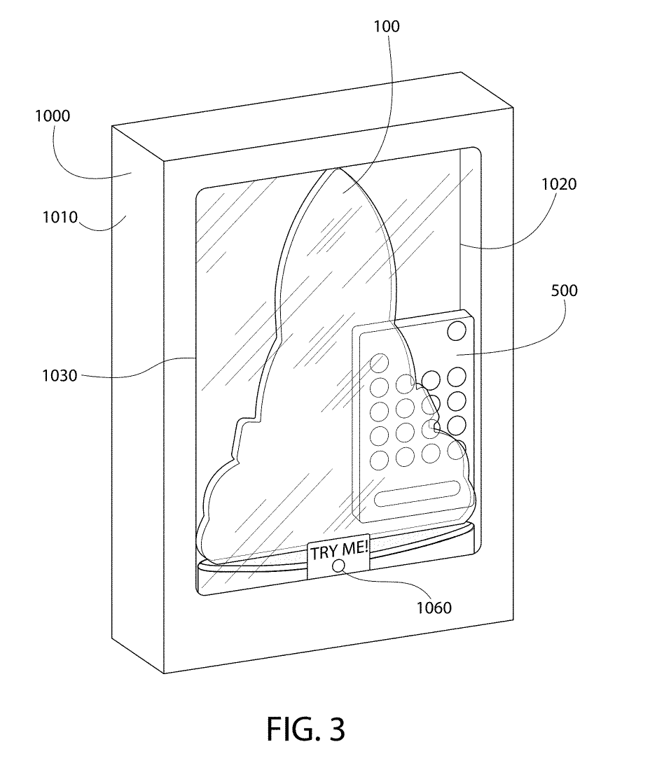

FIG. 3 shows an example of a packaging 1000 for device 100 and a remote control 500. Packaging 1000 includes a min container 1010, a backer card 1020, and a clear product window 1030 for displaying device 100 and remote control 500. Also shown in FIG. 3 is a Try-Me access area 1060 that can be pressed in h a potential buyer to contact enter button 360 (or some other switch) to launch the Try-Me mode discussed above.

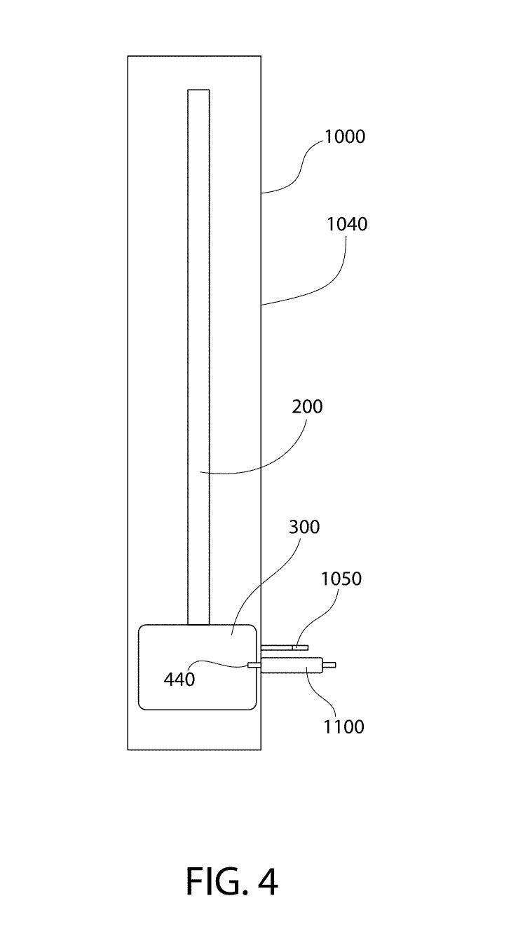

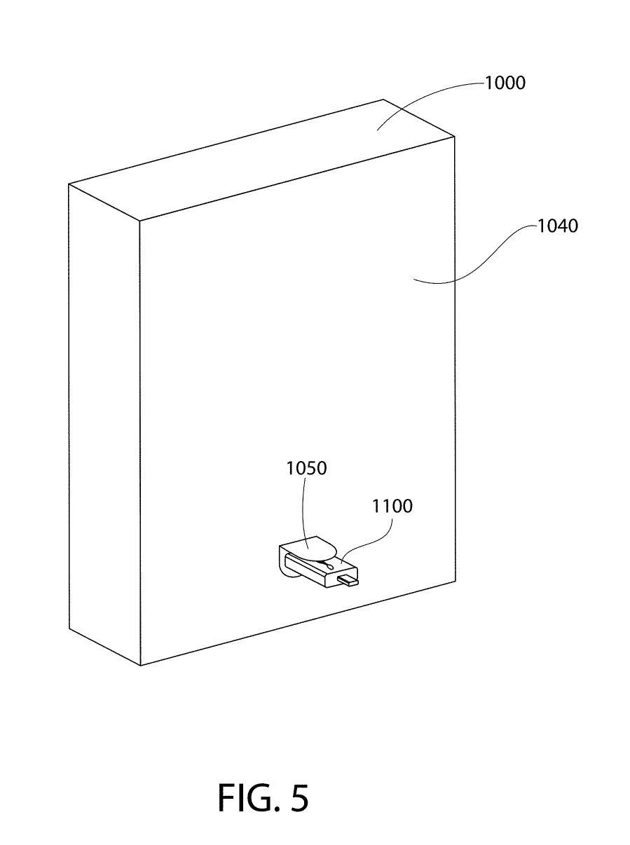

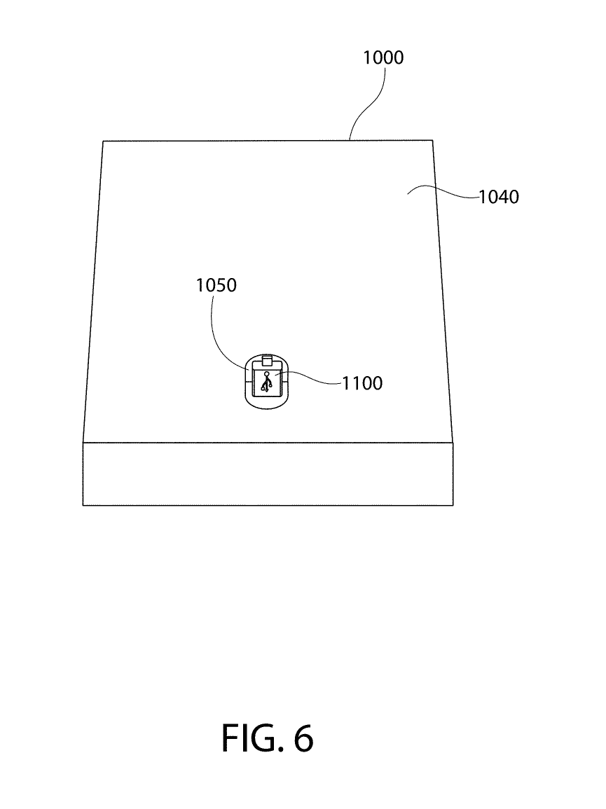

FIGS. 4-6 show schematic views of packaging 1000 containing, upright portion 200 and base 300 of device 100. A rear side 1040 of packaging 1000 includes a flap 1050 that can be opened to reveal external power port 440 on base 300. External power port 440 can be used to provide external power to the processor (during an exhibition, for example) and/or to charge rechargeable batteries located in base 300. A USB device/adapter 1100 is shown connected to external power port 440. This feature provides a convenient means for retailers to demonstrate the features of the product without removing the product from the packaging so it therefore remains a saleable item even when used as a demonstrator model.

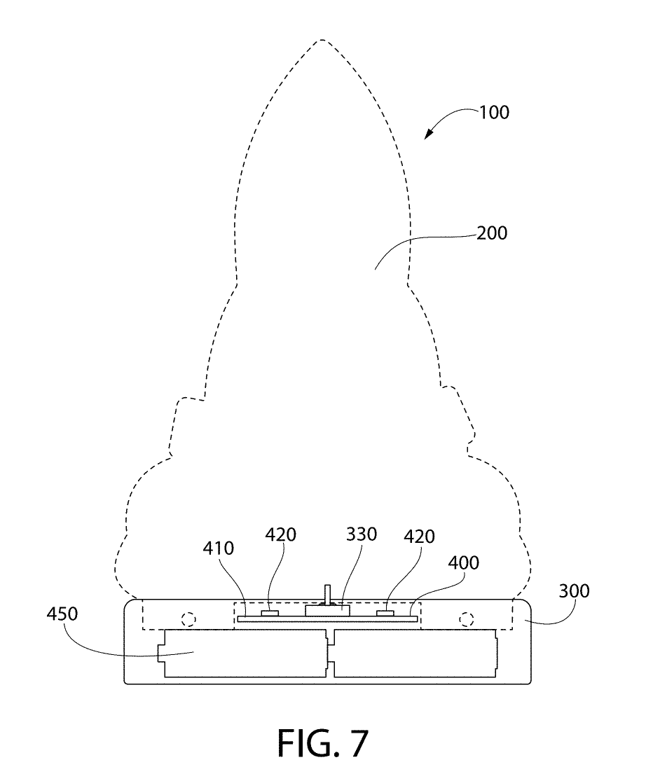

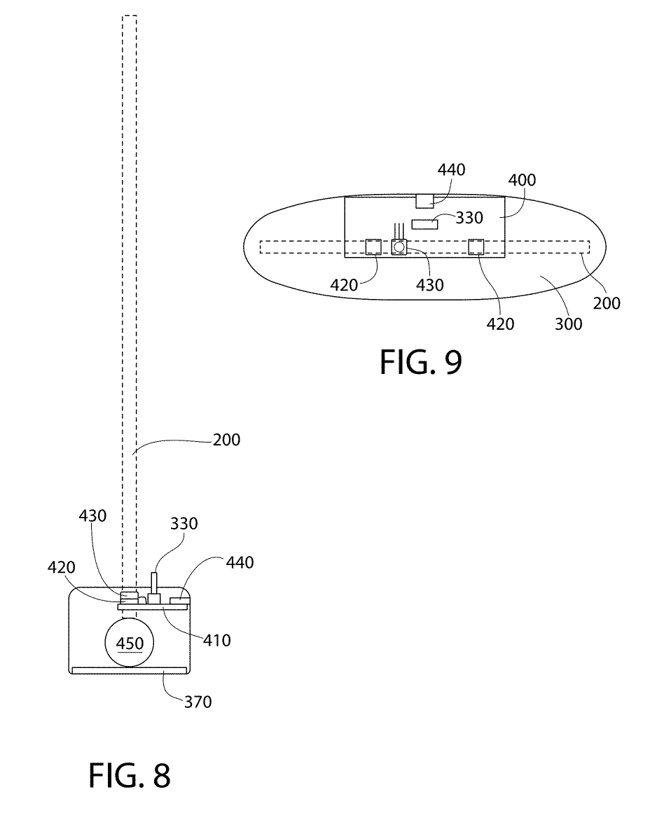

FIGS. 7-9 show and example of elements that are located inside base 300. In this example, base 300 is ABS injection molded and can house two AA batteries 450. Other examples use fewer or more batteries of similar or different types. The batteries can be non-rechargeable or rechargeable. Above the batteries is a Printed Circuit Board Assembly (PCBA) 400, which receives power from batteries 450. PCBA 400 includes a printed circuit board (PCB) 410 to which various devices are mounted. PCBA 400 includes a sliding switch 330 at its center, and one or more RGB LEDs 420 on either side of the switch. An Infra-Red sensor 430 is used to detect commands from the remote control or other Infra-Red capable devices such as, for example, a phone running an app. A USB port 440 is used to receive power (as an alternative to battery power). PCBA 400 includes a processor having instructions for carrying out the various features of the device. As can be seen best in FIG. 8, LEDs 420 are positioned in close proximity to and directly under upright portion 200 of device 100 so that light emitted from LEDs 420 is directed upward into upright portion 200.

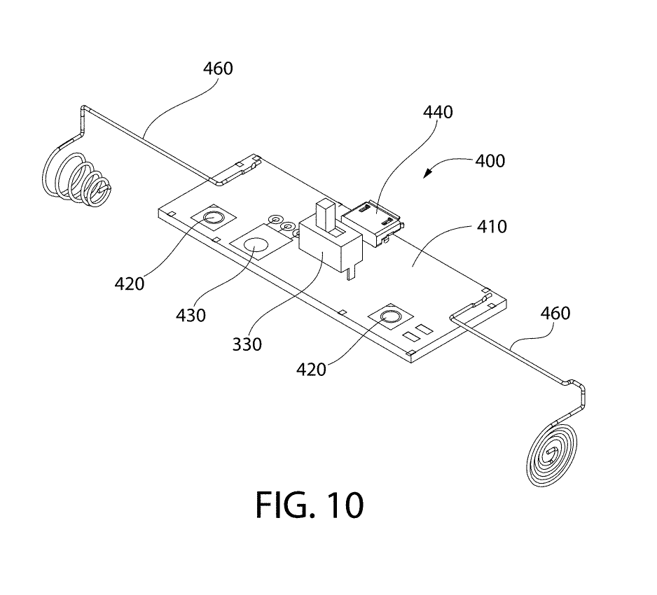

FIG. 10 is another view of PCBA 400 that shows two battery contacts 460 that electrically attach. PCBA 400 to batteries 450. Other designs of battery contacts can also be used.

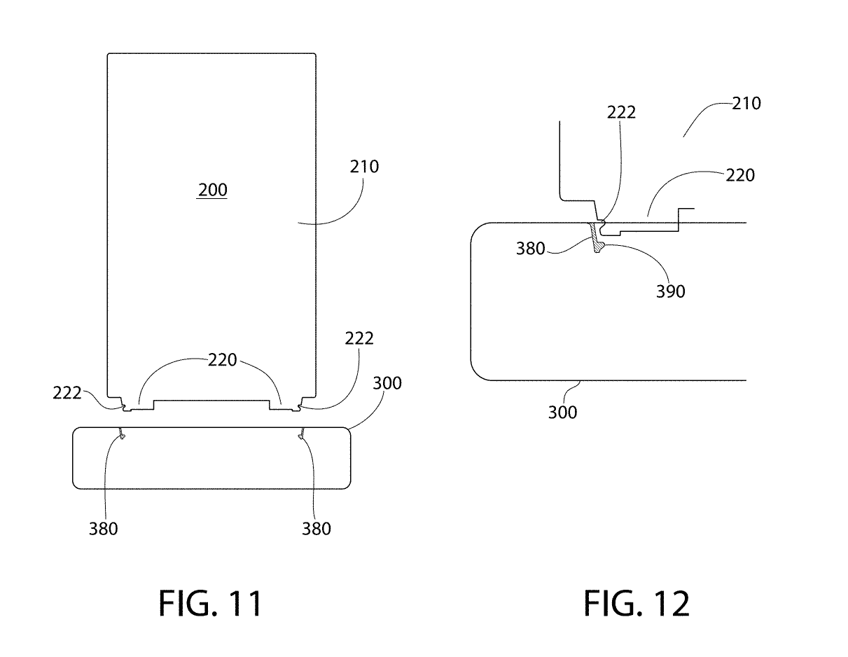

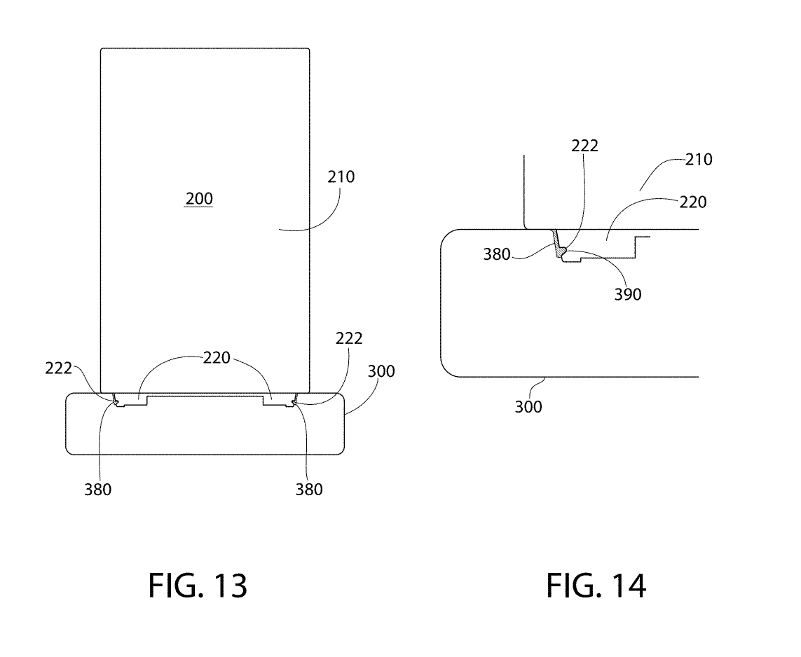

FIGS. 11-14 show an example of a mounting mechanism for at ring upright portion 200 to base 300. In this example, two internal spring clips 380 are ?sided in base 300. Upright portion 200 includes to tabs 220 that extend downwardly from a main body 210 of upright portion 200. Spring clips 380 have protrusions 390 that engage recesses 222 in tabs 220 and thereby lock upright portion 200 to base 300. One advantage of this feature is that it enables more variation in the thickness of the acrylic sheets from which upright portion 200 is produced. This connection method also allows the removal and reattachment of upright portion 200 without damaging either upright portion 200 or base 300. In FIG. 11 upright portion 200 is lowered into position above base 300. FIG. 12 shows tabs 220 being inserted into slot 320 of base 300. FIGS. 13 and 14 show protrusions 390 engaged with recesses 222 to lock upright portion 200 in place in base 300.

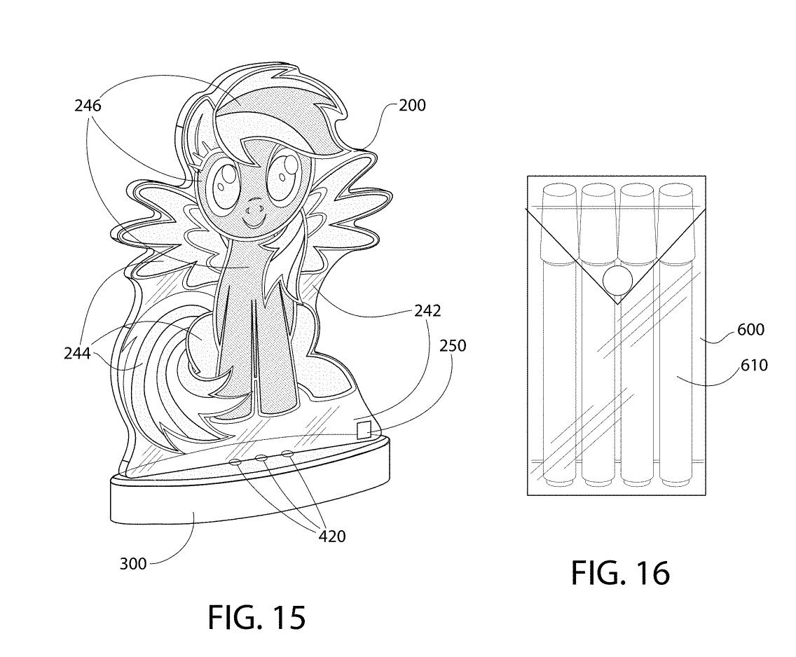

FIG. 15 shows an example of an embodiment of the invention that has areas on upright portion 200 that can be colored by a user. The color can be applied by the user by way of a special pen so that the user can personalize device 100. Three distinct areas on upright portion 200 can be seen on the example shown in FIG. 15. Clear area 242 is an area that can be the normal finish of upright portion 200 with no surface treatment or image. Screened areas 244 and 246 are identical when device 100 is purchased by the user. Screened areas 244 and 246 have, in this example, a coating screened or printed on to the back side of upright portion 200. In this embodiment, all areas 242, 244 and 246 have a surface that can be colored by a user using the special pens. The coating in areas 244 and 246 can be applied in other ways besides screening. Some of the screened areas (colored areas indicated by reference number 246) are shown as having been colored by the user. A particular design or image may or may not have clear areas 242 dispersed within the design or image. Areas 244 and 246 can be, in alternate embodiments, a frosted or rough finish, or some machine applied finish.

Shown on FIG. 15 is a machine readable code, such as a QR code, that is printed on upright portion 200. Code 250 can be readable by a mobile phone, tablet, or other code reading device. Code 250 can also be a RFID chip or other machine readable coding device. Code 250 cart also be unique for every upright portion 200 (like a serial number) which can be for the sole use of the device owner.

Code 250 can access applications on a mobile phone, tablet, other device or the internet. Examples of content that can be accessed are: suggesting coloring schemes, character related video and audio content, phone-based or tablet-based 3D hologram projector content, and control of the light source of device 100 by a phone or tablet app (via Infra-Red, for example) to provide a coordinated “light and sound” show. Device 100 can include Bluetooth technology to provide, for example, a connection with a mobile phone, tablet, or other device for a coordinated “light and sound” show; and: or advanced features such as sleep and wakeup times. A Bluetooth module can be included with device 100 or can be a separate item.

FIG. 16 shows an example of a package 600 of pens/markers 610 that can be used to color upright portion 200. Pens/markers 610 contain a liquid that is formulated to stick to areas 242, 244, 246. In some embodiments, the liquid will be more difficult to remove from areas 244 and 246 than it will be to remove from areas 242 due to the screening/printing in areas 244 and 246. In some embodiments, the coloring liquid gives the best visual presentation when it is applied to the back side and viewed from the from of upright portion 200. In some embodiments, certain areas (that are, for example, roughened) can be colored semi permanently and other areas (that are, for example, smooth) can be erased with, for example, a dry non-scratching cloth.

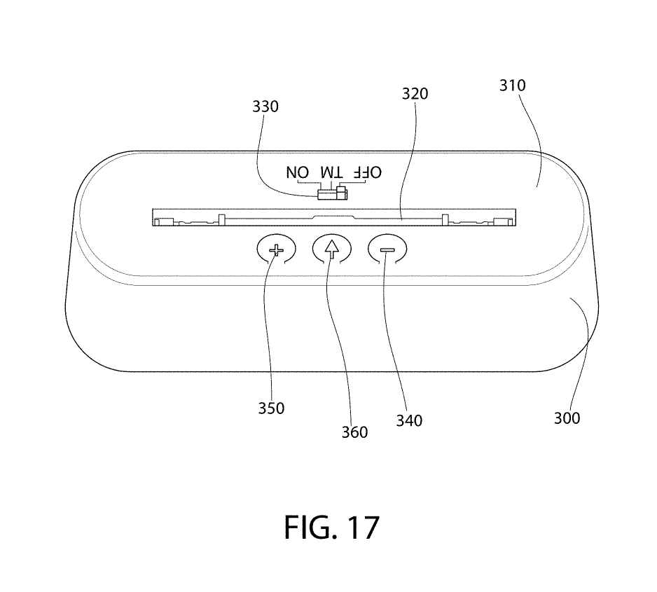

FIG. 17 shows an example of an alternate design for base 300.

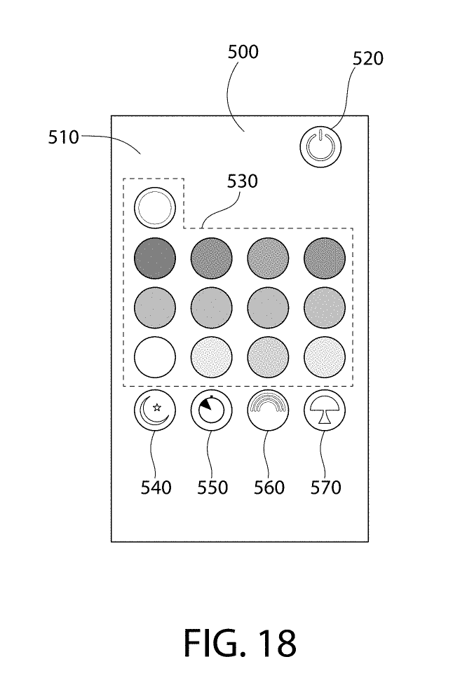

FIG. 18 shows an example of remote control 500. Remote control 500 has a main body 510 on which a plurality of buttons are located. An ON/OFF button 520 instructs device 100 to change from the ON mode to the OFF mode. Color buttons 530 allow the user to select the color of the light emitted by the light source(s). A sleep button >50 instructs the device to gently fade the light to a low level and then stay on at that low light level for eight hours. A Timer button 550 instructs the device to gently fade the light to a low level and then stay on at that low light level for forty minutes and then turn off. A rainbow button 560 instructs the device to cycle through the available colors and then turn off after 20 minutes. Side lamp button 570 instructs the device to turn on the brightest white light for 20 minutes. The side lamp mode is for reading or other activities that require additional light. All of the durations mentioned above are exemplary only and can be different in other embodiments.

Various embodiments of the invention include one of more of the following features: upright portion coloring pens, a Try-Me button assembly, card based packaging (printed CMYK one side), a product backing card (printed CMYK one side), a vacuum formed tray, a multi-language product instruction booklet, a product barcode and retailer specific product labelling, a 200 lb burst test master carton with retailer compliance labelling, and an inner carton (if required for retailer shipping compliance).

To modify the price of the device, different options can be utilized: the device can be supplied with or without the remote control; the product can be supplied with or without one or more of the coloring pens; the product can be supplied with no batteries; the product can be supplied with non-rechargeable batteries; the product can be supplied with a USB port and USB cable, with or without rechargeable batteries; or the product can be supplied with a certified USB Power supply.

Further, the device can include additional features, such as one or more of the following: a sound capability (for example, with a 20×20 mm or 20×30 mm front facing speaker with low bit rate ‘toy’ audio, where a ‘light-n-sound’ show can be initiated using the remote control); double-sided printing of the upright portion for a 3D effect; or lithium polymer (LiPo) batteries.

While the foregoing description and drawings represent exemplary embodiments of the present disclosure, it will be understood that various additions, modifications and substitutions may be made therein without departing from the spirit and scope and range of equivalents of the accompanying claims. In particular, it will he clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may he made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents. In addition, all combinations of any and all of the features described in the disclosure, in any combination, are part of the invention.

What is claimed:

1. An illumination device, comprising:
a base;
an upright portion extending from the base;
a light source located in the base and projecting into the upright portion: and
an electronic controller that controls the light source according to a program, the program including, a plurality of different preprogrammed control functions.

2. The device of claim 1, further comprising an input device connected to the controller and configured to convey a command of a use to the controller.

3. The device of claim 2, wherein the input device is a plurality of contact switches configured to be touched by the user.

4. The device of claim 1, wherein the control functions include changing a color of the light source.

5. The device of claim 1, wherein the control functions include changing an intensity of the light source.

6. The device of claim 1, wherein the control functions include a timed change in a parameter of the light source.

7. The device of claim 1, wherein the control functions include (1) changing a color of the light source, (2) changing an intensity of the light source, and (3) a timed change in a parameter of the light source.

8. The device of claim 7, further comprising a switch having, three positions that include (1) an ON position at which power is supplied to the controller, (2) an OFF position at which no power is supplied to the controller, and (3) a trial position, at which power is supplied to the controller and a trial program is run that exhibits a predefined set of features of the device.

9. The device of claim 8, further comprising an exhibition mode programmed in the controller that controls the light source in a predetermined manner.

10. The device of claim 1, wherein the light source comprises a plurality of individual light sources.

11. The device of claim 1, wherein the upright portion can be removed from the base without damaging the upright portion and without damaging the base, and
the upright portion can be reattached to the base without damaging the upright portion and without damaging the base.

12. The device of claim 1, wherein the upright portion comprises a clear area and a printed area.

13. The device of claim 12, where the primed area is configured to accept a colored liquid applied to the printed area by a user.

14. The device of claim 1, further comprising a switch having three positions that include (1) an ON position at which power is supplied to the controller, (2) an OFF position at which no power is supplied to the controller, and (3) a trial ‘Try-Me’ position at which power is supplied to the controller and a trial program is run that exhibits a predefined set of features of the device.

15. The device of claim 1, further comprising an exhibition mode programmed in the controller that controls the light source in a predetermined manner.

16. The device of claim 15, wherein the predetermined manner can be modified by a user.

17. The device of claim 16, wherein the light source reverts back to the predetermined manner when a set duration has expired with no activity of a remote control.

18. A packaged product combination, comprising:
an illumination device, the illumination device having
a base,
an upright portion extending from the base,
a light source located in the base and projecting into the upright portion,
an electronic controller that controls the light source according to a program, the program including a plurality of different preprogrammed control functions, and
a power supply port in the base that is configured to receive power from an outside source and supply the power to the controller;
a remote controller that can remotely control functions of the illumination device; and
packaging that includes
a container body,
a clear product window in one side of the container body and through which the illumination device can be viewed by a potential buyer of the combination,
an openable and closeable access opening in a first side of the container body, the access opening providing access to the power supply port in the base when the device is in the container body such that the outside power source is electrically connected to the controller.

19. The combination of claim 18, further comprising a user operable switch that activates a demonstration mode of the illumination device, the user operable switch being operable while the illumination device is completely inside the packaging.

20. The combination of claim 19, further comprising an exhibition mode programmed in the controller that controls the light source in a predetermined manner,
wherein the predetermined manner can be modified by a user, and
the light source reverts back to the predetermined manner when a set duration has expired with no activity of the remote control.
